(19) United States
(12) Patent Application Publication
(10) Pub. No.: US 2026/0084166 A1
(43) Pub. Date: Mar. 26, 2026

(54) DEVICE FOR COATING FIBRE-BASED HOLLOW BODIES

(71) Applicant: ALPLA WERKE ALWIN LEHNER GMBH & CO. KG, Hard (AT)

(72) Inventors: Alexander SOHM, Dornbirn (AT); Christian ZMÖLNIG, Schwarzach (AT); Simon SEPPI, Hohenems (AT)

(21) Appl. No.: 19/117,445

(22) PCT Filed: Oct. 6, 2023
(86) PCT No.: PCT/EP2023/077716

§ 371 Date: Apr. 1, 2025

(30) Foreign Application Priority Data
Oct. 6, 2022 (CH) CH001171/2022

(51) Int. Cl. B05B 5/12; B05B 5/08; B05B 13/06; B05D 1/06; B05D 7/22; B65D 23/02

(52) U.S. Cl. CPC B05B 5/12; B05B 5/082; B05B 13/0627; B05B 13/069; B05D 1/06; B05D 7/227; B65D 23/02

(57) ABSTRACT

A device for coating fiber-based hollow bodies with a barrier layer, including an electrically conductive mold with a first port for receiving the body and including a spray lance with a second port, which spray lance can be introduced into the body and through which a polymer powder can be introduced into the body. A power source can be connected to the first and the second port, as a result of which an electric voltage can be realized between the mold and the spray lance. An electrically conductive and compressible compensation element is arranged on the inner side of the mold.

### FIELD OF THE INVENTION

The invention relates to a device for coating fiber-based hollow bodies according to the preamble of claim 1 and to a fiber-based closure according to the preamble of claim 15.

### PRIOR ART

In recent years, fiber materials have gained new importance as packaging materials because they are particularly sustainable. Advances in wet forming technology for components with undercuts such as containers and bottles are opening up new fields of application. Other new technologies such as dry forming of fiber mats enable new fiber-based bodies such as closures. These products compete with previously known products that are mainly made of plastics material. A disadvantage of fiber-based materials is that they are not intrinsically protected against external media such as water or water vapor, as is known from plastics materials. Therefore, for many applications it is necessary to protect the formed fibers in a further process step and to provide the product with barrier properties. There are several technical solutions for applying such a barrier, and a distinction must be made as to which medium the barrier is intended to protect the fiber-based body from and whether, in this case, the filling material is to be protected or the shape of the fiber-based body. External protection can be achieved by introducing chemical additives, e.g. AKD (alkyl ketene dimer), which is well known in the fiber industry and makes fiber surfaces hydrophobic. However, this additive does not provide a barrier to water vapor or other gases, and allows them to penetrate unhindered, thus not adequately protecting the contents.

Coatings for fiber-based containers are known from the prior art, which have a powder coating on the inside of their shell. The powder coating is applied to the shell using an electrostatic high-voltage method. This allows the shell to be equipped with a barrier layer. However, fiber-based bodies have the peculiarity that they have relatively large manufacturing tolerances compared to plastics bodies. Therefore, fiber-based bodies with an electrostatic coating have the disadvantage that the charge region is not uniform and accordingly the coating can have different thicknesses and even gaps.

### OBJECT OF THE INVENTION

The disadvantages of the prior art described give rise to the object of providing a device which improves the coating method described above.

### DESCRIPTION

The stated object is achieved with a device for coating fiber-based hollow bodies with a barrier layer by the features listed in the characterizing part of claim 1. The dependent claims relate to developments and/or advantageous alternative embodiments.

The invention is preferably characterized in that an electrically conductive and compressible compensation element is arranged on the inner side of the mold. Since the manufacturing tolerances of fiber-based hollow bodies are relatively high due to their manufacturing method, it is likely that the inner side of the mold does not fit completely and exactly against the outer side of the hollow body. This can cause the electrical charge to be interrupted, resulting in a patchy and uneven coating. The electrically conductive and compressible compensation element ensures, thanks to its flexibility, that the outer surfaces of the body, whose corresponding inner surfaces are to be coated, are in full surface contact with the compensation element. Defects and irregularities in the coating are therefore reliably prevented.

In a particularly preferred embodiment of the invention, the compensation element is an electrically conductive foam and/or an electrically conductive 3D-printed filament body. The foam is usually used together with an additional carrier element, while the filament body is both the carrier element and the electrical conductor. The foam is preferably a polyurethane foam coated with copper and nickel.

3D printing enables an extremely precise surface and at the same time a high degree of flexibility. The filament body can only be produced exclusively using 3D printing, as it has to be built up in layers to create the intertwined filaments. The intertwined filaments ensure the compressibility and flexibility of the filament body. The filament body is intended for components where the contour of the mold does not allow the conductive foam to be glued on.

In a further particularly preferred embodiment, the mold consists of a plurality of electrically conductive segments, as a result of which the body to be coated can be enclosed by the segments. This means that an electrical charge can be present on all surfaces of the hollow body, which should be coated evenly and without gaps. The segments are preferably made of aluminum because this metal has a high electrical conductivity. The segments can also be free of the foam or the filament body. This is preferred for interfaces of the hollow body that need to transmit force and be screwed together.

The combination of compensation element and segments enables the hollow body to be enclosed by the mold over the entire surface area, and at the same time an electrical voltage is present on all surfaces that are to be coated. For the device to function reliably, these features must work together.

It has proven to be useful if the mold has a plurality of side segments, a bottom segment and a shoulder segment. This means that the hollow body can be easily inserted into the mold and is in full contact with the segments after the mold is closed.

Expediently, the mold has a neck segment and a dividing segment, the dividing segment adjoining the neck segment. The neck segment and the dividing segment form the boundary edge between the coated and the uncoated region on the outer surface of the neck thread. The neck segment is the contacting component and is therefore responsible for potential equalization. The dividing segment does not touch the outer surface of the bottle. This segment results in a “sharper” boundary edge of the coating. The fiber-based hollow body can optionally also be coated on the outside of the front or sealing surface as well as on the thread. As a rule, the coating ends directly behind the end of the thread.

It is advantageous if the dividing segment and the neck segment are free of the compensation element. At this point in the hollow body, the aluminum segment without a compensation element is preferred because it is more conductive than foam and filament bodies and enables a coating that can withstand higher loads due to its improved adhesion. This prevents the coating from coming off at interfaces that transmit force and interfaces that need to be screwed together.

As already explained above, it is advantageous if the coating region on the body can be limited by the dividing segment. This gives the coating a precise demarcation from the non-coated part of the hollow body.

The invention is preferably also characterized in that the segments can be transferred in the manner of a casting mold from an open position, in which the body can be inserted into the mold, into a closed position, in which the body can be completely enclosed by the segments. This makes the device ideal for the series production of fiber-based hollow bodies. The increased manufacturing tolerances of the hollow bodies of a production series are compensated by the compensation element.

In a further preferred embodiment of the invention, the surfaces of the segments which are covered with the compensation element or are free of it define a coating region in the closed position of the mold. This allows the entire interior to be coated particularly homogeneously, thinly and without gaps.

It is preferred if the side segments are covered with foam, since the foam can be glued to the contour of the side segment with an electrically conductive adhesive and thus adheres to the segment. The foam has good conductivity and good compensation properties.

It is preferred if the bottom segment is covered with the filament body, since the foam does not stick to the bottom segment. This is the case because the bottom segment and also the shoulder segment usually always have a contour that cannot be reproduced using foam alone. Specifically, radii, edges and other 3D shapes can be reproduced only with very thin resilient materials. However, foam must usually be about 5 mm thick because, on the one hand, it has a compensating function and, on the other hand, the copper-nickel coating is not resilient. Accordingly, the filament body is a suitable replacement for the foam on contours where the foam does not stick.

The spray lance can expediently be inserted into the mold through the shoulder segment, as this is also where the filling or pouring opening of the fiber-based hollow body is located.

In a further preferred embodiment of the invention, the spray lance is designed such that the polymer powder is electrically charged as it flows through the spray lance, the segments being chargeable opposingly to the polymer powder. This causes the powder particles to be attracted to the inner side of the hollow body, where a potential equalization occurs. The spray lance can be designed like a “corona gun.”

Due to the advantages outlined above, the device is particularly suitable for fiber-based bottles and closures, as the compensation element can compensate for manufacturing tolerances and complex geometric shapes.

A further aspect of the invention relates to a fiber-based closure comprising a cover plate and a cylindrical casing with an internal thread adjoining the cover plate. The inner side of the cover plate and the casing can particularly advantageously be coated with a polymer powder using the present device. On the one hand, the barrier layer is applied evenly and over the entire surface area. On the other hand, the polymer coating increases the rigidity in this region. This can increase the maximum tightening torque of the closure. In addition, the friction surfaces, e.g. the thread, prevent fibers from being released from the surface when the surfaces move against each other, which would impair the function of the closure if the closure is used several times.

Further advantages and features will become apparent from the following description of an embodiment of the invention with reference to the schematic drawings. In the figures, in a representation that is not to scale:

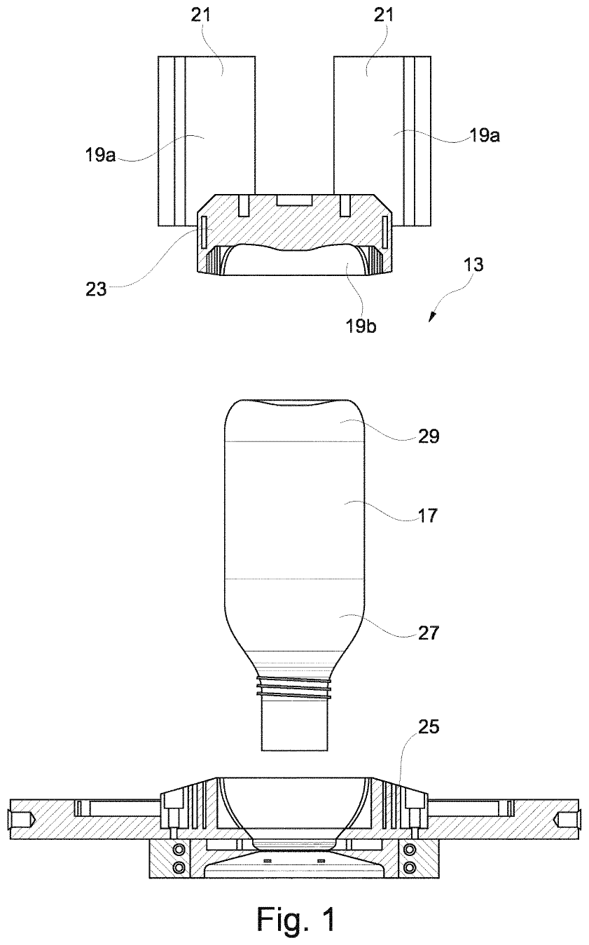

FIG. 1: shows a sectional view of a device for coating fiber-based hollow bodies with a mold, the mold being open;

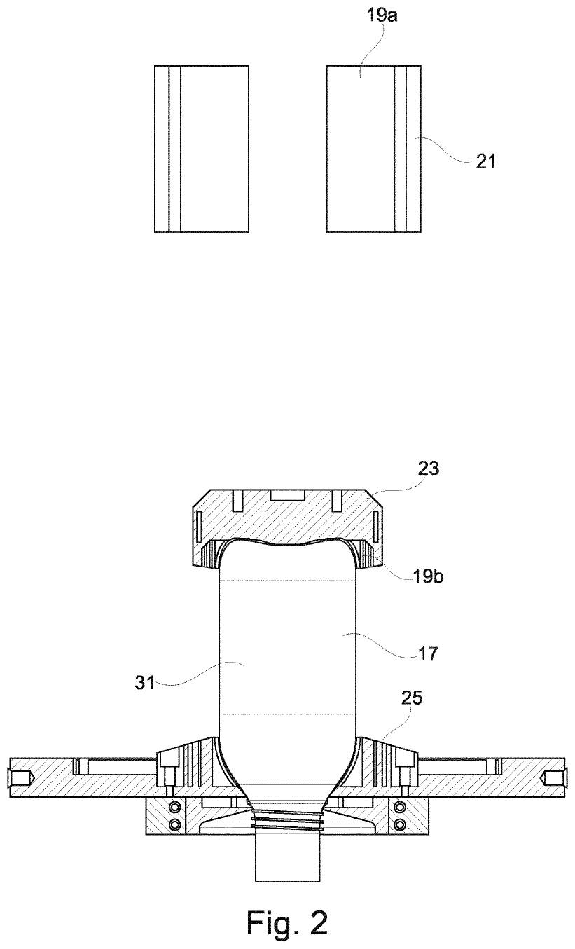

FIG. 2: shows a sectional view of the device in a partially closed position of the mold;

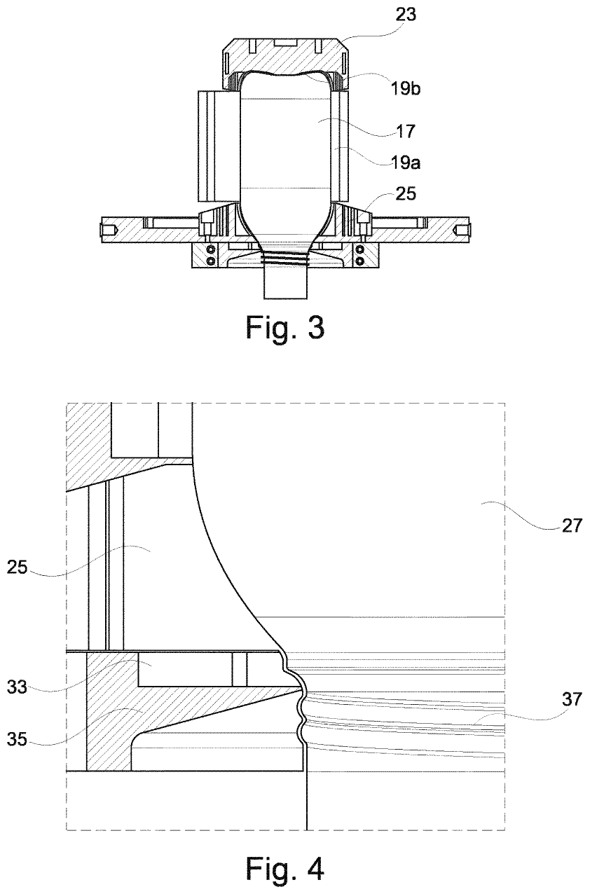

FIG. 3: shows a sectional view of the device in a closed position of the mold;

FIG. 4: shows a detail view of the mold from FIG. 3; and

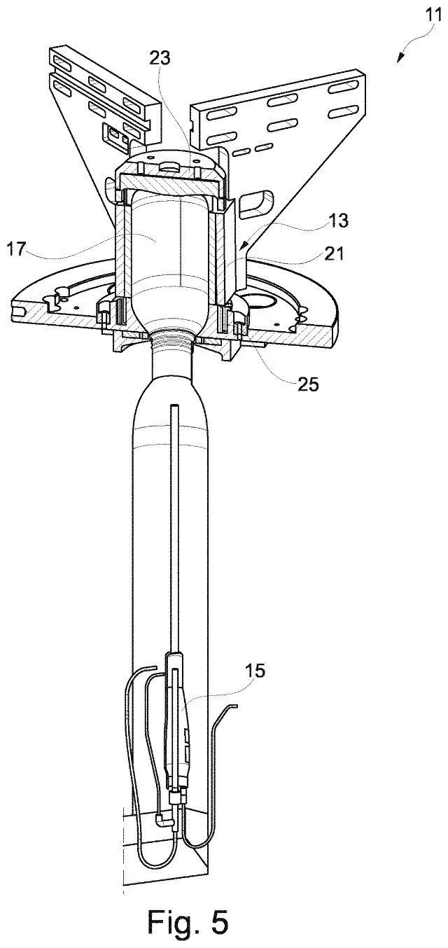

FIG. 5: shows a perspective view of the device with the mold and a spray lance

FIG. 5 shows a device for coating fiber-based hollow bodies, which comprises an electrically conductive mold 13 and a spray lance 15 and is designated overall by the reference sign 11. The mold 13 functions like a casting mold, with mold segments being able to move between an open position (FIG. 1) and a closed position (FIG. 3). In the open position, a hollow body, for example a fiber-based bottle 17, can be inserted into the mold 13. In the context of this application, a fiber-based hollow body is to be understood to mean that the hollow body is formed from compressed pulp, which forms a dimensionally stable shell and encloses an interior space. Pulp is typically understood to mean a mixture of water, fibers (in particular paper fibers) and a binder.

The mold 13 and the spray lance 15 have a first and a second electrical port, respectively, to which an electrical voltage can be applied. Since the mold 13 is made of an electrically conductive material, for example aluminum, the charge can act on the hollow body or bottle 17, even though the fibers are non-conductive. The more precisely the mold 13 fits to the bottle, the more evenly the coating of the interior will be. To coat the inside of the bottle 17, an electrical voltage is applied to the first and second port. For example, a polymer powder blown through the spray lance 15 is positively charged. Since the mold 13 is negatively charged, the powder particles adhere to the inside of the bottle 17. Subsequently, the bottle 17 is removed from the mold 13 and in a subsequent step the powder is melted by thermal energy. In this case, the thermal energy can be introduced in the form of convective energy or radiant energy. The powder forms a homogeneous layer in the melt and solidifies in the subsequent cooling process.

Typically, fiber-based hollow bodies have a relatively large manufacturing tolerance compared to plastics bodies. On the other hand, the mold 13 must fit as precisely and as completely as possible against the hollow body in order to generate a charge field that reproduces the inside of the hollow body as precisely as possible.

In order to achieve this exact fit of the mold 13 on bottles 17, which differ from one another in their dimensions due to the material, an electrically conductive and compressible compensation element 19 is arranged on the inner side of the mold 13. This compensation element 19 lies against the outer contour of the bottle 17 over its entire surface, since it can be compressed to a greater or lesser extent. The coating is therefore particularly homogeneous and thin, and adapts to the geometry of the hollow body on the inside. Even complex shapes such as the threads of a fiber-based screw cap can be coated precisely.

The mold 13 consists of a plurality of electrically conductive segments, as a result of which the body to be coated can be enclosed by the segments. Preferably, the mold 13 has a plurality of side segments 21, a bottom segment 23 and a shoulder segment 25. The segments can be lined with an electrically conductive foam 19a or with an electrically conductive 3D-printed filament body 19b. The filaments are intertwined plastics fibers which are compressible or flexible and are electrically conductive. For components where the contour does not allow the conductive foam to be glued on, the use of the filament body 19b is advantageous. The filament body 19b can be produced with the highest manufacturing tolerances and in complex shapes using the 3D printing method.

Segments, for example the side segments 21, can be lined with an electrically conductive foam 19a. The conductivity and compensation behavior are higher for the conductive foam than for the filament body. The foam is used on all segments where it can be glued to the contour.

The fiber-based bottle 17 is inserted with its shoulder 27 into the shoulder segment 25 (FIG. 1). FIG. 2 shows the fixing of the bottle 17 between the shoulder and the bottom segment 25, 23. The bottle 17 is fixed by moving the bottom segment 23 vertically onto the base 29. After closing the bottom segment 23, the side segments 21 are closed, as a result of which the bottle is completely surrounded by segments. Preferably, four side segments 21 are provided, which are moved first in the vertical and then in the radial direction in order to cover the casing of the bottle 31. The inner surfaces of the side segments 21 are covered with the electrically conductive foam 19a. After closing the segments, the surfaces of the segments which are covered with the compensation element 19 define a coating region in the closed position of the mold 13 (FIG. 3). That is to say that all surfaces of the bottle 17 which are connected to the compensation element 19 (foam 19a or filament body 19b) can be coated over the entire surface, evenly and without gaps, with the electrically charged polymer powder.

Following on from the shoulder segment 25, the mold 13 has a neck segment 33. The neck segment 33 and an adjoining dividing segment 35 are closed by means of two pneumatic grippers. The neck segment is the contacting component which is responsible for the potential equalization.

The dividing segment 35 is provided following on from the neck segment 33. The neck segment 33 ensures a coating at the transition between the shoulder 27 and the neck 33. The dividing segment 35 enables a clean separation or a “sharper boundary edge” on the neck of the bottle 37 between the coating zone and the outer mouth region, which is not coated. For establishing the interfaces, neither the neck segment 33 nor the dividing segment 35 have a compensation element. These two segments are made of aluminum and therefore have good conductivity.

FIG. 5 shows the spray lance 15 before it is inserted through the shoulder segment 25 into the interior of the bottle 17. The spray lance can be designed as a “corona gun.” When leaving the spray lance 15, the polymer powder is charged with the counter charge of the electrically conductive compensation element 19. This allows the powder to adhere to the inner surfaces of the bottle that are to be coated.

The 3D-printed filament body 19b and in particular the foam 19a enable geometrically complex shapes to be coated with a thin polymer layer having a uniform layer thickness. In addition, the polymer layer is completely closed, in order to create a reliable barrier layer. Therefore, the device 11 is also suitable for coating the inside of a fiber-based screw cap. In this case, the internal thread of the closure is also completely coated. By using a polymer powder, which adheres extensively to the geometric shapes, the rigidity is also increased in this region. This can increase the maximum tightening torque of the closure. In addition, the friction surfaces, e.g. the thread, prevent fibers from being released from the surface when the surfaces move against each other, which would impair the function of the closure if the closure is used several times.

### List of Reference Signs

11 device
13 mold
15 spray lance
17 fiber-based bottle, fiber-based hollow body
19 compensation element
19a electrically conductive foam
19b electrically conductive 3D-printed filament body
21 side segments
23 bottom segment
25 shoulder segment
27 shoulder of the bottle
29 bottom of the bottle
31 casing of the bottle
33 neck segment
35 dividing segment
37 neck of the bottle

1-15. (canceled)

16. A device for coating fiber-based hollow bodies with a barrier layer, comprising:
an electrically conductive mold with a first port for receiving the body,
a spray lance for dispensing a polymer powder with a second port, which spray lance can be positioned at a distance from the body,
a power source being connectable to the first and the second port, as a result of which an electric voltage can be realized between the mold and the spray lance, wherein
an electrically conductive and compressible compensation element is arranged on the inner side of the mold.

17. The device according to claim 16, wherein the compensation element is an electrically conductive foam and/or an electrically conductive 3D-printed filament body.

18. The device according to claim 16, wherein the mold consists of a plurality of electrically conductive segments, as a result of which the body to be coated can be enclosed by the segments.

19. The device according to claim 18, wherein the mold has a plurality of side segments, a bottom segment and a shoulder segment.

20. The device according to claim 18, wherein the mold has a neck segment and a dividing segment, the dividing segment adjoining the neck segment.

21. The device according to claim 20, wherein the dividing segment and the neck segment are free of the compensation element.

22. The device according to claim 20, wherein the coating region on the body can be limited by the dividing segment.

23. The device according to claim 16, wherein the segments can be transferred in the manner of a casting mold from an open position, in which the body can be inserted into the mold, into a closed position, in which the body can be completely enclosed by the segments.

24. The device according to claim 16, wherein the surfaces of the segments which are covered with the compensation element or are free of it define a coating region in the closed position of the mold.

25. The device according to claim 17, wherein the side segments are covered with foam.

26. The device according to claim 17, wherein the bottom segment is covered by the filament body.

27. The device according to claim 16, wherein the spray lance can be inserted into the mold through the shoulder segment.

28. The device according to claim 16, wherein the spray lance is designed such that the polymer powder is electrically charged when flowing through the spray lance, it being possible for the segments to be charged opposingly to the polymer powder.

29. Use of the device according to claim 16, for coating fiber-based containers, in particular fiber-based bottles and fiber-based closures.

30. Fiber-based closure, comprising:
a cover plate and
a cylindrical casing connected to the cover plate and having an internal thread, wherein
at least the inner side of the cover plate and the casing is coated with a device according to claim 16.
